(19) United States
(12) Patent Application Publication
(10) Pub. No.: US 2005/0208246 A1
(43) Pub. Date: Sep. 22, 2005

(54) Low cost conductive pipe manufactured from conductive loaded resin-based materials

(75) Inventor: Thomas Aisenbrey, Littleton, CO (US)

Correspondence Address: GEORGE O. SAILE, 28 DAVIS AVENUE, POUGHKEEPSIE, NY, 12603, US

(73) Assignee: Integral Technologies, Inc.

(21) Appl. No.: 11/121,681

(22) Filed: May 4, 2005

Related U.S. Application Data
(63) Continuation-in-part of application No. 10/877,092, filed on Jun. 25, 2004.
Application No. 10/877,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. B32B 1/08

(52) U.S. Cl. 428/36.9

(57) ABSTRACT

Conductive pipe are formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are formed from non-metals, such as carbon, graphite, that may also be metallic plated, or the like, or from metals such as stainless steel, nickel, copper, silver, that may also be metallic plated, or the like, or from a combination of non-metal, plated, or in combination with, metal powders. The micron conductor fibers preferably are of nickel plated carbon fiber, stainless steel fiber, copper fiber, silver fiber, aluminum fiber, or the like.

### RELATED PATENT APPLICATIONS

This patent application is related to U.S. patent application INT04-005B, Ser. No. ______, and filed on ______, which is herein incorporated by reference in its entirety.

This patent application claims priority to the U.S. Provisional Patent Application 60/469,514, filed on May 6, 2004, which is herein incorporated by reference in its entirety.

This patent application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, now issued as U.S. Pat. No. 6,870,516, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001, all of which are incorporated by reference in their entirety.

### BACKGROUND OF THE INVENTION

(1) Field of the Invention

This invention relates to conductive pipe and, more particularly, to conductive pipe molded of conductive loaded resin-based materials comprising micron conductive powders, micron conductive fibers, or a combination thereof, substantially homogenized within a base resin when molded. This manufacturing process yields a conductive part or material usable within the EMF or electronic spectrum(s).

(2) Description of the Prior Art

Metal piping is used in a variety of applications, especially in the transport of liquids and gases. Metal piping is typically constructed of iron or copper. Metal pipes prove impervious to many liquids and gases and are good conductors of thermal energy and electrical current. Therefore, metal pipes are useful for liquid/gas heating and cooling as well as for a grounded conduit for electrical wiring. Metal piping has several disadvantages. First, metal piping, especially iron piping, is heavy. Second, metal piping can be expensive as in the case of copper pipe. Third, metal piping can be reactive with certain types of liquid/gas materials.

Resin-based piping has been used for many years as a substitute for metal-based material. Poly vinyl chloride (PVC) is used in many applications, especially in household plumbing, to replace copper or metal pipe. Resin-based material is non-reactive with many liquids and gases, is less expensive than metal, and is lighter than metal. However, resin-based material typically is not a good conductor of thermal or electrical energy. Therefore, resin-based pipe is not acceptable for use in heating and cooling applications or for use as a grounded conduit of electrical wiring. It is an important object of the present invention to provide a resin-based piping material having excellent thermal and electrical conductivity while retaining low cost and weight.

Several prior art inventions relate to piping. U.S. Pat. No. 4,429,213 to Mathieu teaches an electrical resistance heating sleeve for a plastic pipe. The sleeve itself comprises a polymer having conductive particles therein. The conductive particles comprise carbonaceous particles. U.S. Pat. No. 4,515,737 to Karino et al teaches a method to form a composite, plastic pipe with glass fibers wound into the pipe walls. U.S. Pat. No. 6,263,921 B1 to He teaches a method for fabricating a composite plastic pipe with a netted wire skeleton.

### SUMMARY OF THE INVENTION

A principal object of the present invention is to provide an effective conductive pipe.

A further object of the present invention is to provide a method to form conductive pipe.

A further object of the present invention is to provide a conductive pipe molded of conductive loaded resin-based materials.

A yet further object of the present invention is to provide conductive pipe molded of conductive loaded resin-based material where the conductive pipe thermal or electrical characteristics can be altered or the visual characteristics can be altered by forming a metal layer over the conductive loaded resin-based material.

A yet further object of the present invention is to provide methods to fabricate a conductive pipe from a conductive loaded resin-based material incorporating various forms of the material.

A yet further object of the present invention a magnetic or magnetizable, conductive pipe is made from a conductive loaded resin-based material by adding a ferromagnetic conductive loading.

In accordance with the objects of this invention, a conductive pipe device is achieved. The device comprises a hollow sleeve having a first opening and a second opening. The hollow shell comprises a conductive loaded, resin-based material comprising conductive materials in a base resin host.

Also in accordance with the objects of this invention, a conductive pipe device is achieved. The device comprises a hollow shell having a first opening and a second opening. The hollow sleeve comprises a conductive loaded, resin-based material comprising conductive materials in a base resin host. The percent by weight of the conductive materials is between 20% and 50% of the total weight of the conductive loaded resin-based material.

Also in accordance with the objects of this invention, a conductive pipe device is achieved. The device comprises a hollow sleeve having a first opening and a second opening. The hollow shell comprises a conductive loaded, resin-based material comprising micron conductive fiber in a base resin host. The percent by weight of the conductive fiber is between 20% and 50% of the total weight of the conductive loaded resin-based material.

Also in accordance with the objects of this invention, a method to form a conductive pipe device is achieved. The method comprises providing a conductive loaded, resin-based material comprising conductive materials in a resin-based host. The conductive loaded, resin-based material is molded into a hollow sleeve having a first opening and a second opening.

Also in accordance with the objects of this invention, a method to form a conductive pipe device is achieved. The method comprises providing a conductive loaded, resin-based material comprising conductive materials in a resin-based host. The percent by weight of the conductive materials is between 20% and 40% of the total weight of the conductive loaded resin-based material. The conductive loaded, resin-based material is molded into a hollow sleeve having a first opening and a second opening.

Also in accordance with the objects of this invention, a method to form a conductive pipe device is achieved. The method comprises providing a conductive loaded, resin-based material comprising micron conductive fiber in a resin-based host. The percent by weight of the micron conductive fiber is between 20% and 50% of the total weight of the conductive loaded resin-based material. The conductive loaded, resin-based material is molded into a hollow sleeve having a first opening and a second opening.

### BRIEF DESCRIPTION OF THE DRAWINGS

In the accompanying drawings forming a material part of this description, there is shown:

FIG. 1 illustrates a first preferred embodiment of the present invention showing a conductive pipe comprising a conductive loaded resin-based material.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold conductive pipe of a conductive loaded resin-based material.

FIGS. 7a and 7b illustrate a second preferred embodiment of the present invention showing a refrigeration system for an ice skating rink using the conductive pipe.

FIG. 8 illustrates a third preferred embodiment of the present invention showing the conductive pipe applied to an electrical distribution system.

### DESCRIPTION OF THE PREFERRED EMBODIMENTS

This invention relates to conductive pipe molded of conductive loaded resin-based materials comprising micron conductive powders, micron conductive fibers, or a combination thereof, substantially homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are substantially homogenized within the resin during the molding process, providing the electrical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of conductive pipe fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the conductive pipe are substantially homogenized together using molding techniques and or methods such as injection molding, over-molding, insert molding, thermo-set, protrusion, extrusion or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

In the conductive loaded resin-based material, electrons travel from point to point when under stress, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive loading concentration, that is, the separation between the conductive loading particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductive loaded resin-based material are altered when molded into a structure. A substantially homogenized conductive microstructure of delocalized valance electrons is created. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

The use of conductive loaded resin-based materials in the fabrication of conductive pipe significantly lowers the cost of materials and the design and manufacturing processes used to hold ease of close tolerances, by forming these materials into desired shapes and sizes. The conductive pipe can be manufactured into infinite shapes and sizes using conventional forming methods such as injection molding, over-molding, or extrusion or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are substantially homogenized together within the base resin, during the molding process, yielding an easy to produce low cost, electrically conductive, close tolerance manufactured part or circuit. The resulting molded article comprises a three dimensional, continuous network of conductive loading and polymer matrix. The micron conductive powders can be of carbons, graphites, amines or the like, and/or of metal powders such as nickel, copper, silver, aluminum, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. The micron conductive fibers may be metal fiber or metal plated fiber. Further, the metal plated fiber may be formed by metal plating onto a metal fiber or metal plating onto a non-metal fiber. Exemplary micron conductive fibers include nickel plated carbon fiber, stainless steel fiber, copper fiber, silver fiber, aluminum fiber, or the like, or combinations thereof. Metal plating for fiber include copper, nickel, cobalt, silver, gold, palladium, platinum, ruthenium, and rhodium, and alloys of thereof. Non-metal fiber cores include carbon, graphite, polyester, and other synthetic materials. Superconductor metals, such as titanium, nickel, niobium, and zirconium, and alloys of titanium, nickel, niobium, and zirconium may also be used as micron conductive fibers in the present invention. The structural material is a material such as any polymer resin. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion to create desired shapes and sizes. The molded conductive loaded resin-based materials can also be stamped, cut or milled as desired to form create the desired shape form factor(s) of the conductive pipe. The doping composition and directionality associated with the micron conductors within the loaded base resins can affect the electrical and structural characteristics of the conductive pipe and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming conductive pipe that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in conductive pipe applications as described herein.

The substantially homogeneous mixing of micron conductive fiber and/or micron conductive powder and base resin described in the present invention may also be described as doping. That is, the substantially homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder into a base resin.

As an additional and important feature of the present invention, the molded conductor loaded resin-based material exhibits excellent thermal dissipation characteristics. Therefore, conductive pipe manufactured from the molded conductor loaded resin-based material can provide added thermal dissipation capabilities to the application. For example, heat can be dissipated from electrical devices physically and/or electrically connected to conductive pipe of the present invention.

As a significant advantage of the present invention, conductive pipe constructed of the conductive loaded resin-based material can be easily interfaced to an electrical circuit or grounded. In one embodiment, a wire can be attached to a conductive loaded resin-based conductive pipe via a screw that is fastened to the conductive pipe. For example, a simple sheet-metal type, self tapping screw, when fastened to the material, can achieve excellent electrical connectivity via the conductive matrix of the conductive loaded resin-based material. To facilitate this approach a boss may be molded into the conductive loaded resin-based material to accommodate such a screw. Alternatively, if a solderable screw material, such as copper, is used, then a wire can be soldered to the screw that is embedded into the conductive loaded resin-based material. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the conductive pipe and a grounding wire.

A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

Another method to provide connectivity to the conductive loaded resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductive loaded resin-based material at the location of the applied solderable ink. Many other types of solderable inks can be used to provide this solderable surface onto the conductive loaded resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductive loaded resin-based material may be formed of the present invention to create a magnetic or magnetizable form of the material. Ferromagnetic micron conductive fibers and/or ferromagnetic conductive powders are mixed with the base resin. Ferrite materials and/or rare earth magnetic materials are added as a conductive loading to the base resin. With the substantially homogeneous mixing of the ferromagnetic micron conductive fibers and/or micron conductive powders, the ferromagnetic conductive loaded resin-based material is able to produce an excellent low cost, low weight magnetize-able item. The magnets and magnetic devices of the present invention can be magnetized during or after the molding process. The magnetic strength of the magnets and magnetic devices can be varied by adjusting the amount of ferromagnetic micron conductive fibers and/or ferromagnetic micron conductive powders that are incorporated with the base resin. By increasing the amount of the ferromagnetic doping, the strength of the magnet or magnetic devices is increased. The substantially homogenous mixing of the conductive fiber network allows for a substantial amount of fiber to be added to the base resin without causing the structural integrity of the item to decline. The ferromagnetic conductive loaded resin-based magnets display the excellent physical properties of the base resin, including flexibility, moldability, strength, and resistance to environmental corrosion, along with excellent magnetic ability. In addition, the unique ferromagnetic conductive loaded resin-based material facilitates formation of items that exhibit excellent thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fiber to cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductive loaded resin-based material may be magnetized, after molding, by exposing the molded article to a strong magnetic field. Alternatively, a strong magnetic field may be used to magnetize the ferromagnetic conductive loaded resin-based material during the molding process.

Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary non-ferromagnetic conductor fibers include stainless steel, nickel, copper, silver, aluminum, or other suitable metals or conductive fibers, alloys, plated materials, or combinations thereof. Superconductor metals, such as titanium, nickel, niobium, and zirconium, and alloys of titanium, nickel, niobium, and zirconium may also be used as micron conductive fibers in the present invention. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials.

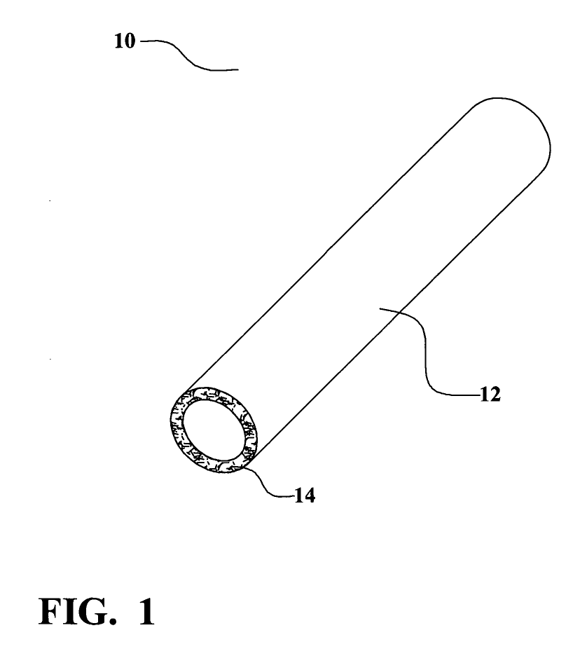

Referring now to FIG. 1, a first preferred embodiment of the present invention is illustrated. A very low cost conductive pipe 12 is manufactured from conductive loaded resin-based materials according to the present invention. Several important features of the present invention are shown and discussed below. A first preferred embodiment 10 of the present invention shows a conductive pipe 12 molded from conductive loaded molded base resin 14. The conductive loaded molded base resin conductive pipe 12 can be formed into almost any shape that is required for the application. Further, the conductive loaded molded base resin conductive pipe 12 may be formed using resin-based materials 14 that remain flexible after setting. For example, Surlyn™ of the Dupont Corporation may be used to make a conductive loaded molded base resin conductive pipe 12 that is flexible. Alternatively, a semi-rigid resin-based material, such as Noryl PPX™ from the General Electric Corporation or Lexan™, may be used to form a conductive loaded molded base resin conductive pipe 12 that is semi-rigid.

The conductive loaded resin-based pipe 12 has several distinct advantages over the prior art. Like metal-based pipe, such as cast iron “black pipe” or copper tubing, the conductive loaded resin-based pipe 12 is thermally and electrically conductive. Therefore, the conductive loaded resin-based pipe 12 can be substituted for metal piping in many applications where thermal and electrical conductivity is required. However, the conductive loaded resin-based pipe 12 can be manufactured for far less cost than metal piping, especially when compared to copper tubing. Conversely, the conductive loaded resin-based pipe 12 shares an additional advantage with known plastic pipe alternatives, such as polyethylene, polyvinyl chloride (PVC), or the like. First, the conductive loaded resin-based pipe is lower in weight than metal pipe. Second the conductive loaded resin-based pipe can be easily manufactured into many useful shapes and components. Third, the conductive loaded resin-based pipe can be easily assembled in the field. Fourth, the conductive loaded resin-based pipe does not corrode.

As an optional feature, a metal layer may be formed on the conductive loaded resin-based material after it has been molded. The metal layer alters the performance characteristics, such as strength, resistivity, appearance, and/or thermal dissipation capability, of the resulting, composite pipe. If used, the metal layer may be formed by plating or by coating. If the method of formation is metal plating, then the resin-based structural material of the conductive loaded, resin-based material is one that can be metal plated. There are very many of the polymer resins that can be plated with metal layers. The metal layer may be formed by, for example, electroplating or physical vapor deposition.

As another optional embodiment, an insulating layer is formed on the conductive loaded resin-based material pipe 12. In one embodiment, the conductive loaded resin-based material is co-extruded onto a resin-based pipe such that an insulting layer is formed lining the conductive loaded resin-based material pipe 14. This embodiment is particular useful for applications where it is necessary to keep the contents of the pipe electrically isolated from the pipe 12 while the pipe 12 is connected to an electrical potential or to ground. In another embodiment, a resin-based material is co-extruded onto the conductive loaded resin-based material 14 such that an insulating layer is formed onto the conductive loaded resin-based pipe 14. This embodiment is particularly useful for applications where it is necessary to electrically isolate the exterior of the pipe 12 while electrically connecting the pipe 12 and its contents to an electrical potential or to ground.

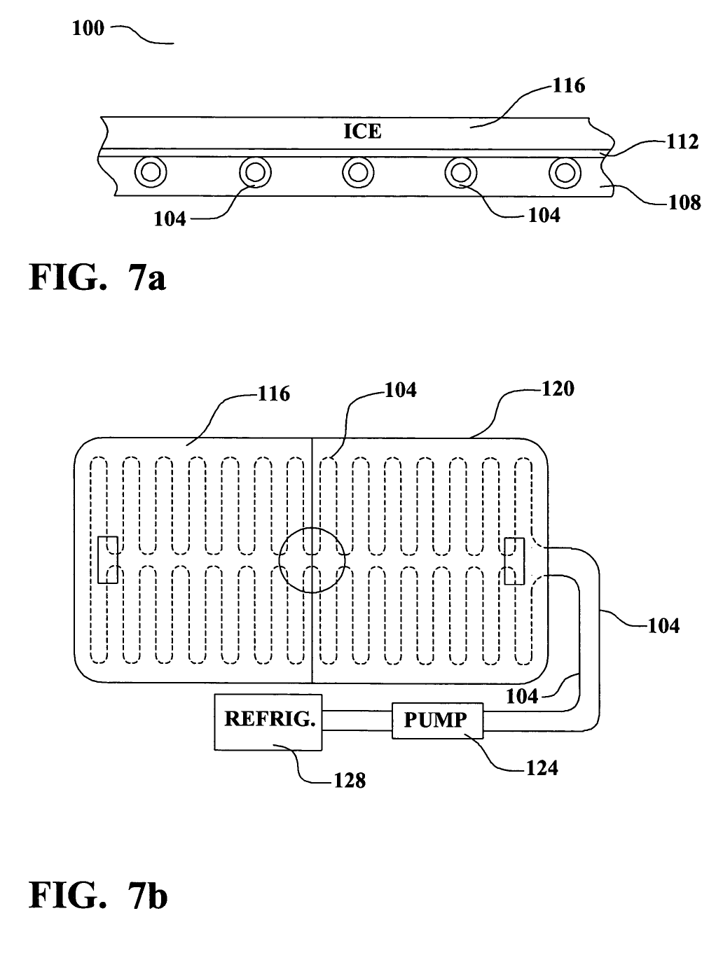

Referring now to FIGS. 7a and 7b, a second preferred embodiment of the present invention is illustrated. In this application, the conductive loaded resin-based pipe is used for an ice skating rink refrigeration system 100. A side view is shown in FIG. 7a, while an overall top view is shown in FIG. 7b. The conductive loaded resin-based pipe 104 is assembled into a refrigeration configuration in a base material 108 underlying a typical ice rink membrane 112. The conductive loaded resin-based pipe 104 conducts heat away from the overlying ice 116 and into a refrigerant conducted within the piping system. A refrigerator 128 and pumping system 124 is used to flow the refrigerant through the conductive loaded resin-based piping system. The excellent thermal conductivity of the conductive loaded resin-based pipe 104 facilitates an ice rink refrigeration system with lower material and assembly costs than a comparable, metal piping system.

A related application is the use of a conductive loaded resin-based pipe for radiant heating systems where a heated liquid flows through a piping circuit to thereby transfer heat from the heated liquid and into the receiving ambient. For example, the conductive loaded resin-based pipe may be embedded into a concrete floor or wall and used to heat a house or a basement. Once again, the economic and performance advantages of the conductive loaded resin-based pipe would be a significant improvement over the current art. A radiant floor heating system is similar to an ice rink refrigeration system except that the refrigerator 128 is replaced with a heating source. For example, typical radiant floor heating systems use plastic tubing such as polyethylene, polyvinyl chloride (PVC), or the like, to transport a heated fluid such as ethylene glycol. The conductive loaded resin-based piping system of the present invention exhibits higher thermal conductivity than, for example, polyethylene. Therefore, the radiant floor heating system using the conductive loaded resin-based pipe transfers the heat energy of the fluid more efficiently to the floor than the prior art system.

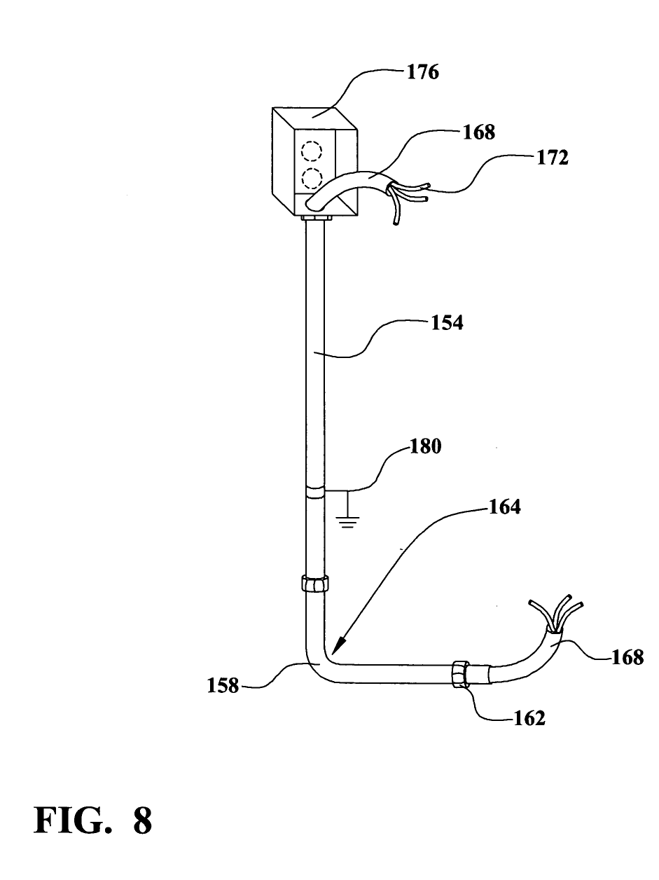

Referring now to FIG. 8, a third preferred embodiment of the present invention is illustrated. In this case, the conductive loaded resin-based pipe is used as electrical conduit 154 for an electrical distribution system. Electrical codes frequently require that electrical conductors 168 and 172 be carried in metal conduit. For example, if a wiring circuit cannot be hidden within a wall system, then the conductors must be carried in conduit. Further, this conduit may have to be connected to the building or earth ground 180. Typical plastic piping is not suitable for these purposes since it is not electrically conductive. However, the conductive loaded resin-based pipe 154 of the present invention may be suitable as an electrical conduit due to its excellent electrical conductivity. The conductive loaded resin-based pipe 154 can be preformed into useful shapes, such as right angle bends 158, couplings 162, and electric boxes 176. Substantial material and labor savings may be achieved by the elimination of expensive metal piping, boxes, and labor-intensive pipe bending as is typical in the electrical contracting art.

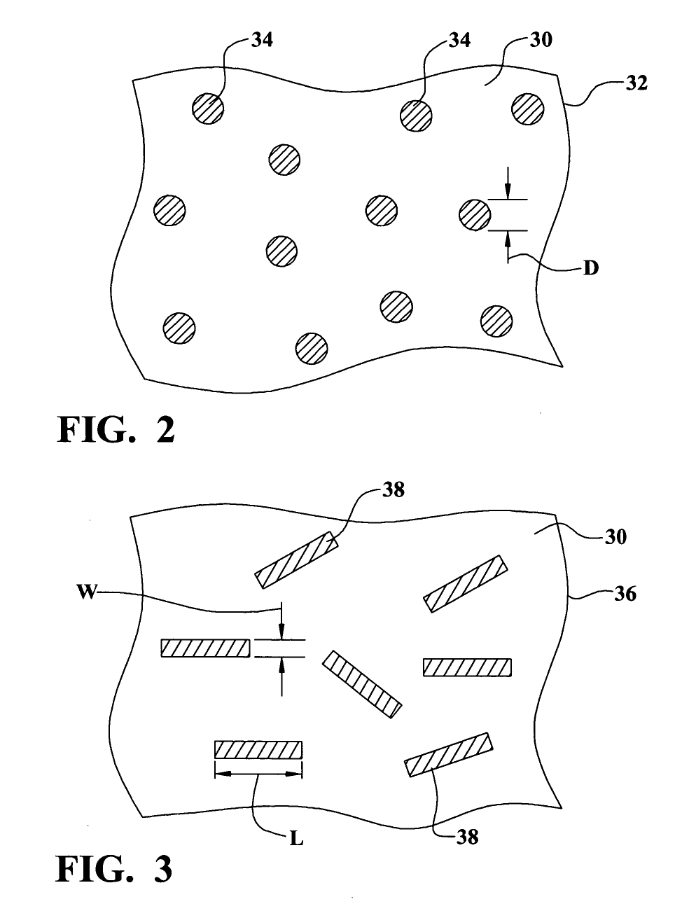

The conductive loaded resin-based material of the present invention typically comprises a micron powder(s) of conductor particles and/or in combination of micron fiber(s) substantially homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

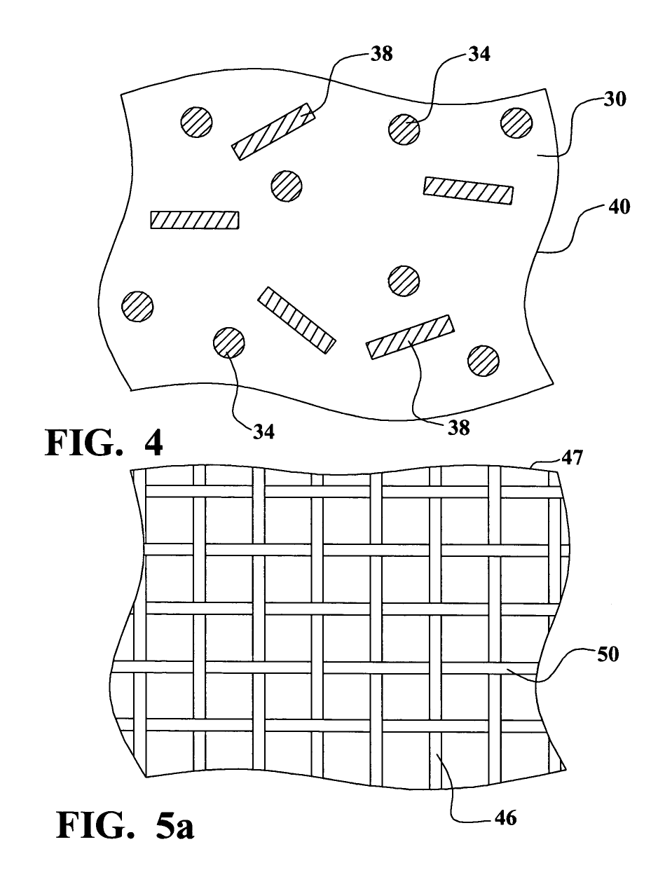

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The conductors used for these conductor particles 34 or conductor fibers 38 can be stainless steel, nickel, copper, silver, aluminum, or other suitable metals or conductive fibers, or combinations thereof. Superconductor metals, such as titanium, nickel, niobium, and zirconium, and alloys of titanium, nickel, niobium, and zirconium may also be used as micron conductive fibers in the present invention. These conductor particles and or fibers are substantially homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 6-12 micron in diameter and lengths of 4-6 mm and comprising, by weight, about 30% of the total weight of the conductive loaded resin-based material will produce a very highly conductive parameter, efficient within any EMF spectrum. Referring now to FIG. 4, another preferred embodiment of the present invention is illustrated where the conductive materials comprise a combination of both conductive powders 34 and micron conductive fibers 38 substantially homogenized together within the resin base 30 during a molding process.

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

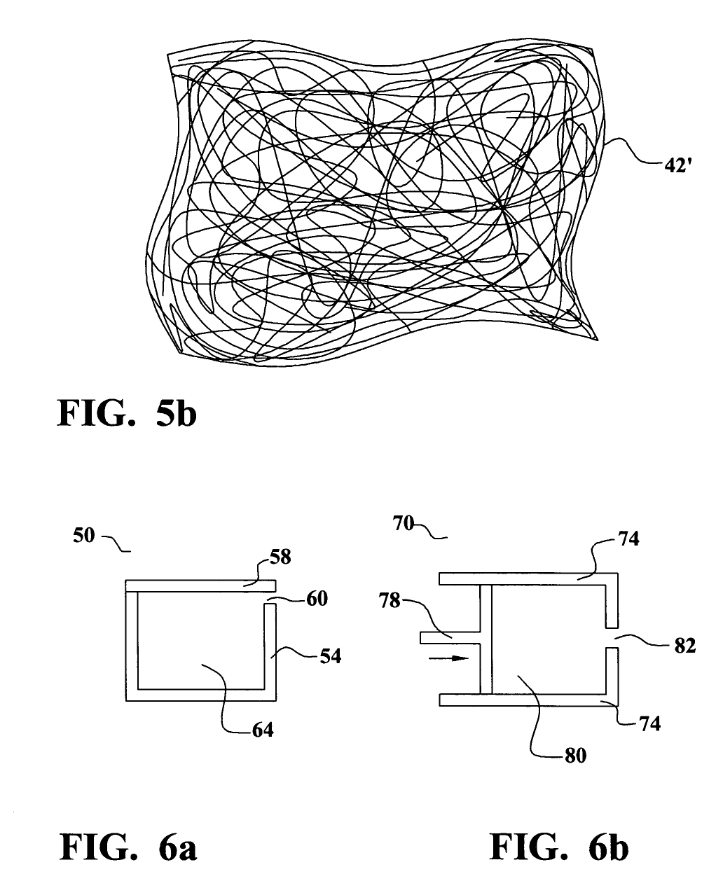

Conductive pipe formed from conductive loaded resin-based materials can be formed or molded in a number of different ways including injection molding, extrusion or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the substantially homogenized conductive material cures by thermal reaction. The upper portion 58 and lower portion 54 of the mold are then separated, or parted, and the conductive pipe is removed.

FIG. 6b shows a simplified schematic diagram of an extruder 70 for forming conductive pipe using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. An effective conductive pipe is achieved. A method to form conductive pipe is also achieved. The conductive pipe is molded of conductive loaded resin-based materials. The thermal or electrical characteristics can be altered or the visual characteristics can be altered by forming a metal layer over the conductive loaded resin-based material. Methods to fabricate a conductive pipe from a conductive loaded resin-based material incorporating various forms of the material are achieved. The conductive pipe may be made magnetic or magnetizable.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

1. A conductive pipe device comprising a hollow sleeve having a first opening and a second opening wherein said hollow shell comprises a conductive loaded, resin-based material comprising conductive materials in a base resin host.

2. The device according to claim 1 wherein the percent by weight of said conductive materials is between about 20% and about 50% of the total weight of said conductive loaded resin-based material.

3. The device according to claim 1 wherein said conductive materials comprise micron conductive fiber.

4. The device according to claim 2 wherein said conductive materials further comprise conductive powder.

5. The device according to claim 1 wherein said conductive materials are metal.

6. The device according to claim 1 wherein said conductive materials are non-conductive materials with metal plating.

7. The device according to claim 1 further comprising a metal layer on said hollow sleeve of conductive loaded resin-based material.

8. The device according to claim 1 further comprising an insulating layer lining said hollow sleeve of conductive loaded resin-based material.

9. The device according to claim 1 further comprising an insulating layer surrounding said hollow sleeve of conductive loaded resin-based material.

10. The device according to claim 1 further comprising an insulating layer of resin-based material on said hollow sleeve of conductive loaded resin-based material.

11. A conductive pipe device comprising a hollow shell having a first opening and a second opening wherein said hollow sleeve comprises a conductive loaded, resin-based material comprising conductive materials in a base resin host wherein the percent by weight of said conductive materials is between 20% and 50% of the total weight of said conductive loaded resin-based material.

12. The device according to claim 11 wherein said conductive materials are nickel plated carbon micron fiber, stainless steel micron fiber, copper micron fiber, silver micron fiber or combinations thereof.

13. The device according to claim 11 wherein said conductive materials comprise micron conductive fiber and conductive powder.

14. The device according to claim 13 wherein said conductive powder is nickel, copper, or silver.

15. The device according to claim 13 wherein said conductive powder is a non-conductive material with a metal plating of nickel, copper, silver, or alloys thereof.

16. The device according to claim 11 further comprising a metal layer on said hollow sleeve of conductive loaded resin-based material.

17. The device according to claim 11 further comprising an insulating layer lining said hollow sleeve of conductive loaded resin-based material.

18. The device according to claim 11 further comprising an insulating layer surrounding said hollow sleeve of conductive loaded resin-based material.

19. The device according to claim 11 further comprising an insulating layer of resin-based material on said hollow sleeve of conductive loaded resin-based material.

20. A conductive pipe device comprising a hollow sleeve having a first opening and a second opening wherein said hollow shell comprises a conductive loaded, resin-based material comprising micron conductive fiber in a base resin host wherein the percent by weight of said conductive fiber is between 20% and 50% of the total weight of said conductive loaded resin-based material.

21. The device according to claim 20 wherein said micron conductive fiber is stainless steel.

22. The device according to claim 21 further comprising conductive powder.

23. The device according to claim 21 wherein said micron conductive fiber has a diameter of between about 3 μm and about 12 μm and a length of between about 2 mm and about 14 mm.

24. The device according to claim 21 further comprising a metal layer on said hollow sleeve of conductive loaded resin-based material.

25. The device according to claim 21 further comprising an insulating layer on said hollow sleeve of conductive loaded resin-based material.
